(19) United States
(12) Patent Application Publication
(10) Pub. No.: US 2018/0053365 A1
(43) Pub. Date: Feb. 22, 2018

(54) PACKAGE AS A KEY

(71) Applicant: Wal-Mart Stores, Inc., Bentonville, AR (US)

(72) Inventors: Brian Bode, Bentonville, AR (US); John Paul Thompson, Bentonville, AR (US); Robert C. Taylor, Rogers, AR (US)

(21) Appl. No.: 15/642,374

(22) Filed: Jul. 6, 2017

Related U.S. Application Data
(60) Provisional application No. 62/375,628, filed on Aug. 16, 2016.

(51) Int. Cl. G07C 9/00; G06K 7/14; G06K 7/10; H04N 7/18

(52) U.S. Cl. CPC G07C 9/00896; G07C 9/00182; G06K 7/1413; G06Q 10/083; G06K 7/10297; H04N 7/183; G06K 7/1417

(57) ABSTRACT

A system for securely and automatically opening an entrance to a building to receive a delivered package is described. A customer interacts with an e-commerce system to purchase a product online. The system has a delivery company deliver the product and the package to the building identified by the customer. The package has an identification device attached to it that carries unique information received from the e-commerce system. The building has a smart doorbell which can read package information from the identification device. The smart doorbell is connected to a system controller which communicates with and receives package information from the e-commerce system. If they match, the system controller opens an automated lock opening an entrance of the building to receive the package. A video camera provides images of the delivery person entering the building and leaving the package, for security.

### RELATED APPLICATIONS

This application claims the benefit of U.S. Provisional Patent No. 62/375,628, filed Aug. 16, 2016, entitled “Package as Key,” the contents of which are incorporated by reference herein in their entirety.

### FIELD

Aspects of the present invention relate to a system for automatically opening an entrance to the building to receive packages delivered to the building, and more specifically for a secure system for automatically opening an entrance to a building to receive packages delivered to the building.

### BACKGROUND

Purchasing products online is a large business and is becoming larger. These products are typically delivered as packages to customers' homes. Many times they may be delivered during the day when the customer is not at home. Since these packages are left many times on porches or near the house in the yard they are prone to theft.

Attempts have been made to create systems to receive packages. For example U.S. Application 2015/0120529 A1, published Apr. 30, 2015 “Door Access and Package Delivery”, and U.S. Application 2015/0156031 A1 published Jun. 4, 2015 “Environmental Sensing With a Doorbell at a Smart Home” both naming Google, Inc. as the applicant, and both hereby incorporated by reference as if set forth in their entirety herein, describe a system for receiving a package. However, these do not implement a secondary independent verification system. One may possibly find out the code and get access to a person's home.

Currently, there is a need for a secure, automated system for receiving a package at a building when there is no one present.

### BRIEF SUMMARY

According to aspects of the present inventive concepts there is provided an apparatus and method as set forth in the appended claims. Other features of the inventive concepts will be apparent from the dependent claims, and the description which follows.

At least one embodiment of the current invention provides an automatic system for receiving a package purchased through an e-commerce system that is delivered to a building. The system includes an identification device having package information attached to the package.

A local controller at the building adapted to communicate with the e-commerce system to receive package and delivery information.

An automated lock at the building functions to lock or unlock an entrance to the building when activated.

A smart doorbell device is adapted to include a package recognition device and functions to acquire the package information from the identification device when activated and the package is placed near the automated doorbell device.

The local controller is coupled to the automated lock and the doorbell recognition device, and activates the automated doorbell device to acquire package information from the identification device. It also compares the package information acquired from the doorbell recognition device to package information provided by the e-commerce system to determine if they match.

The local controller also receives a time of arrival information (TOA) of the package to the building and creates a delivery time window around the TOA.

The local controller activates the automated lock to unlock an entrance to the building if the acquired package information from the doorbell recognition device is consistent with the package information provided by the e-commerce system, and the package is received within the delivery time window.

The current invention may also be described as a method of automatically receiving a package ordered through an e-commerce system and delivered to a building by providing an identification device having package information on the package, communicating package and delivery information from the e-commerce system to a local controller, placing the package in proximity to a doorbell recognition device, acquiring package information from the identification device by a doorbell recognition device.

The method also includes creating a delivery time window from the delivery information, comparing the package information from the doorbell recognition device to the package information provided by the e-commerce system, unlocking an automated lock on an entrance to the building when the doorbell recognition device identifies the package within the delivery time window, allowing a delivery person to bring the package inside the building, and locking the entrance after the delivery person has left.

The method may further include monitoring the actions of the delivery person when inside of the building. It includes acquiring information about the delivery company from a delivery company identification device that includes information on the delivery company. The method further includes reading the delivery company information from company identification device with the doorbell recognition device to verify the identity of the delivery company.

The current invention may also be described as an automatic system for receiving a package that was purchased on an e-commerce system that is delivered to a building having a home automation system capable of unlocking an entrance to the building. The automatic system includes an identification device having package information on the package, a local controller at the building that communicates with the e-commerce system to receive package and delivery information which includes a delivery time window, an automated lock on the building functioning to unlock and lock an entrance when activated, and a doorbell recognition device able to acquire package information from the identification device when the package is placed near the automated doorbell device, when the automated doorbell device is activated.

The automatic system having the local controller coupled to the automated lock and the doorbell recognition device, functions to activate the automated doorbell device to acquire information from the identification device within a delivery window, compare the package information acquired from the doorbell recognition device to package information provided by the e-commerce system; and activate the home control system to unlock and open the entrance if the acquired package information from the doorbell recognition device is consistent with the package information provided by the e-commerce system, and within the delivery time window.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help improve understanding of various example embodiments. Also, common but well-understood elements that are useful or necessary in a commercially feasible embodiment are often not depicted in order to facilitate a less obstructed view of these various example embodiments.

FIG. 1 shows the delivery person and delivery vehicle delivering a package purchased by a customer on-line that is being delivered to a building indicated by the customer;

FIG. 2 shows the interaction between equipment in the building, the package, the delivery person and the e-commerce site;

FIG. 3 is an enlarged schematic block diagram showing the major parts of the automatic system for receiving a package according to the present invention;

FIG. 4 shows an alternative embodiment of the present invention in which the garage door is automatically opened to receive the delivered package;

FIG. 5 is a modified flow diagram showing the interaction between various elements of the system for receiving a package at a door of the building;

FIG. 6 is a modified flow diagram showing the interaction of various elements of the system for receiving a package into a garage of the building.

### DETAILED DESCRIPTION

The current invention attempts to solve the problems indicated in the “Background” above. It effectively allows the package being delivered to be a key to the home owner's door. In conjunction with other equipment, it allows a delivery person delivering a package to have access to a home or apartment. This allows the delivery person to put the package just inside the homeowner's property in a secure manner. The owner's door is then locked after the package has been received.

This invention involves using a smart lock, smart doorbell (with camera), and an internal camera to allow a door to be automatically unlocked so that a package can be set just inside the door (instead of left on the porch.)

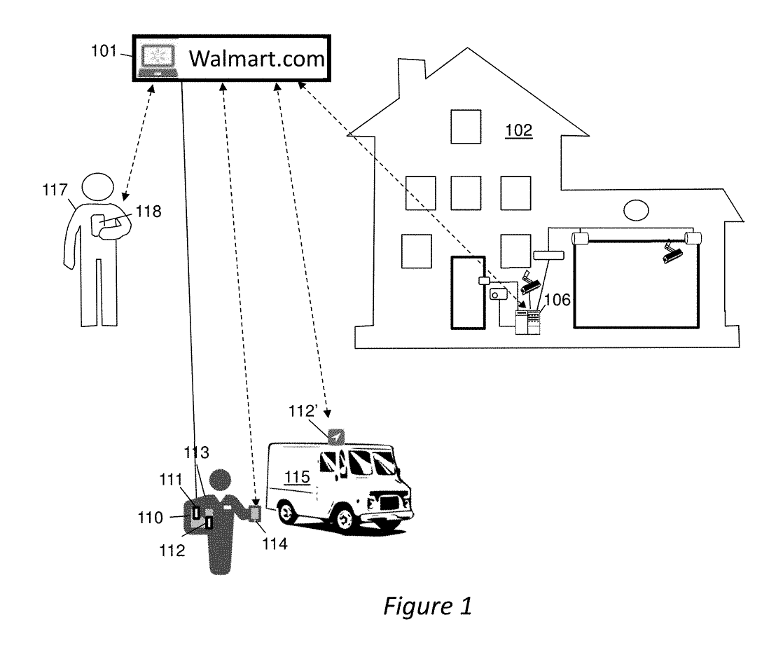

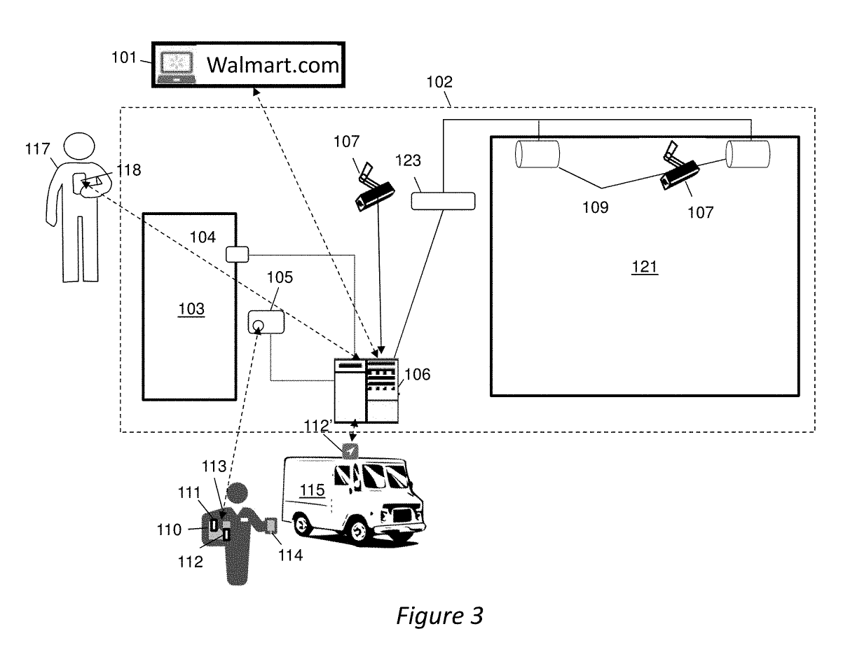

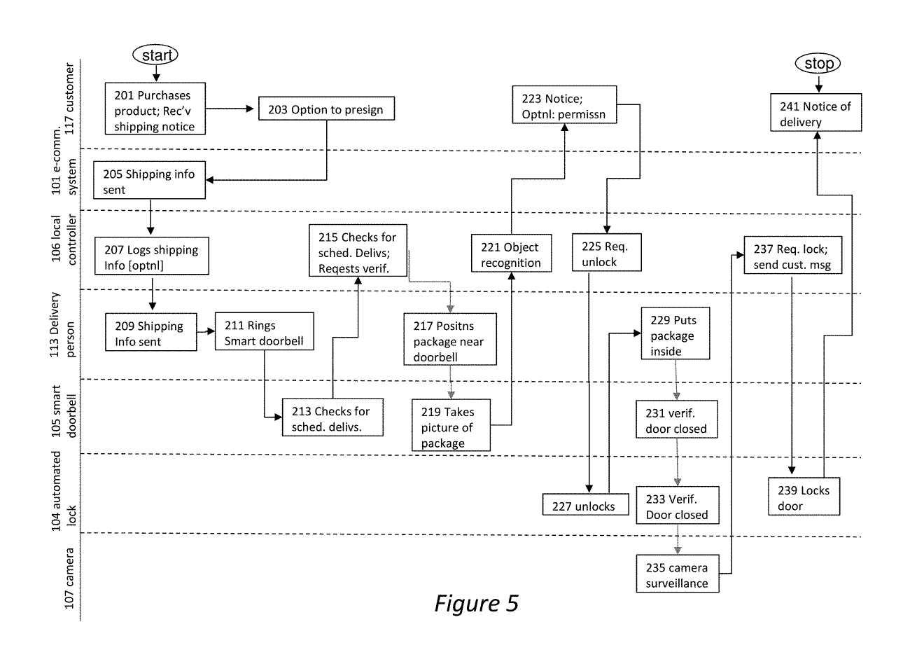

The structure and functioning of the automated system 100 for receiving a package will be described in connection with the workflow diagram of FIG. 5 and the structure shown in FIGS. 1 and 3.

In step 201, a customer 117 interacts through a customer's mobile device 118 to connect to a website of an e-commerce site 101 to purchase a product on-line. This product is intended to be delivered as a package 110 to a delivery location (building 102) identified by customer 117. The customer 117 typically receives a shipping notice on customer's mobile device 118 from e-commerce system 101.

In step 203, the customer 117 is given an option to authorize delivery without requiring a signature when delivered. This is referred to pre-signing for package 110.

In step 205, e-commerce system 101 sends shipping information a local controller 106 in building 102. This shipping information may indicate package information, such as the type and size of the package, a predetermined code, such as a barcode, and some other identifying information allowing local controller 106 to identify the package. The shipping information may also indicate the date/time of arrival, or a time window of arrival being a period of time around an estimated time of arrival.

In step 207, local controller 106 logs the information received.

In step 209, a package delivery company, indicated in FIG. 1 by driver/delivery person 113 and delivery vehicle 115 transports package 110 to building 102 for delivery. The delivery person 113 and delivery vehicle 115 may be from a separate delivery company.

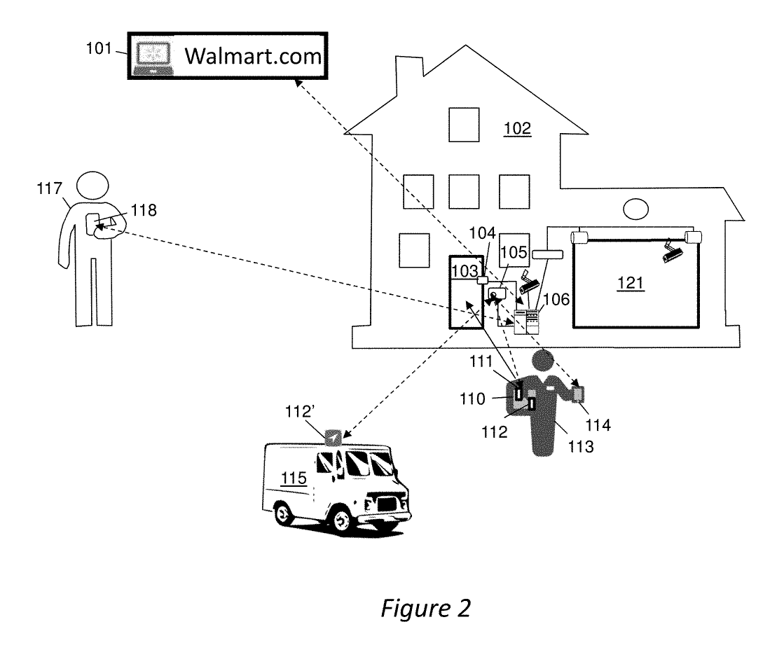

Now referring to FIGS. 5 and 2, in step 211, delivery person 113 rings a smart doorbell 105.

In step 213, the smart doorbell 105 interacts with local controller 106 to indicate that the doorbell was rung.

In step 215 the local controller 106 determine if it is close to a delivery time of arrival (TOA) or within a delivery time window for delivery of a package 110. In one embodiment, the TOA is provided by the ecommerce system 101.

In another embodiment, if a separate delivery company is being used, the delivery company may provide the TOA.

In still another embodiment, there is a tracking device 112 on the package that is tracked during delivery and the TOA is updated based upon the tracking information.

In another embodiment, there is a tracking device 112′ on the delivery vehicle 115 is tracked during delivery and the TOA is updated based upon the tracking information.

If the package is being delivered within the delivery time window, a message is provided to the delivery person 113 to position the package 110 and identification device 111 in a location/position so that the smart doorbell 105 can read package information from identification device 111. The message may be an audible message sent to a speaker in smart doorbell 105, a text message printed on the messaging screen on smart doorbell 105, or other means of locally notifying delivery person 113 of the instructions.

The smart doorbell 105 includes a package recognition device 119.

In one embodiment, the identification device 111 may be a barcode and the package recognition device 119 may be a barcode reader.

In another embodiment the identification device 111 might be an RFID tag, and the package recognition device 119 can be an RFID reader.

In another embodiment the identification device 111 may be a magnetic strip with coded information and the package recognition device 119 has the capability to read information from the magnetic strip.

In another embodiment, the identification device 111 may be a QR code, and the package recognition device 119 is a QR code reader.

In still another embodiment the identification device is a visible feature, and the package recognition device 119 is a camera.

The information acquired by package recognition device 119 is then sent to local controller 106 for processing in step 219.

In step 221, local controller 106 processes the information received, then compares it to package information previously received from e-commerce site 101.

Optionally, in step 223 customer 117 receives a message on customer's mobile device 118 indicating that the package 110 is being delivered.

In step 225 local controller 106 activates automated door lock 104 to unlocked door 103.

In an alternative embodiment, local controller 106 receives permission from customer 117 on customer's mobile device 118 before unlocking door 103.

In an alternative embodiment, local controller 106 is coupled to sensors, such as motion sensor, which can determine if there is a person present in the building. If so, the local controller 106 has built-in logic which will not unlock the door to allow the delivery person to deliver the package.

Also in an alternative embodiment, if the local controller 106 determines that there is at least one person in the building, it may indicate change the delivery to be made to the garage, or other predetermined location. The processing then follow as described for delivery to the garage as explained below. Upon changing the delivery location, some type of notice will be displayed to the delivery person, possibly through the smart doorbell, indicating the change in delivery location.

In step 227 automated lock 104 unlocks door 103.

Optionally, internal cameras 107 may be activated to monitor the actions of delivery person 113.

In step 229 delivery person 113 opens door 103 and sets package 110 inside of door 103. In step 231, smart doorbell 105 senses that delivery person 113 has closed the door.

In step 233, automated lock 104 also verifies that the door 103 has been closed.

In step 235, camera 107 verifies that the package has been delivered and that the delivery person 113 has not wandered into building 102.

In step 237 local controller 106 provides a command to automated lock 104 to lock door 103.

In step 239, automated lock 104 locks door 103.

And in step 241, local controller 106 sends a notification to customer's mobile device 118 notifying customer 117 that the package 110 has been delivered and it is secured within building 102.

### Alternative Embodiments

In an alternative embodiment, a secondary identification may be required for additional security. This may be that the local controller 106 receives information form the delivery company as to the identity of the delivery person 113 or the delivery vehicle 115. The identity of the delivery person is then checked by the smart doorbell 105/local controller 106. This may be by interacting with driver's mobile device 114. Alternatively, the location of the vehicle 115 may be determined by finding tracking device 112′. If the delivery vehicle 115 is in the vicinity, it is probably the proper package 110 being delivered.

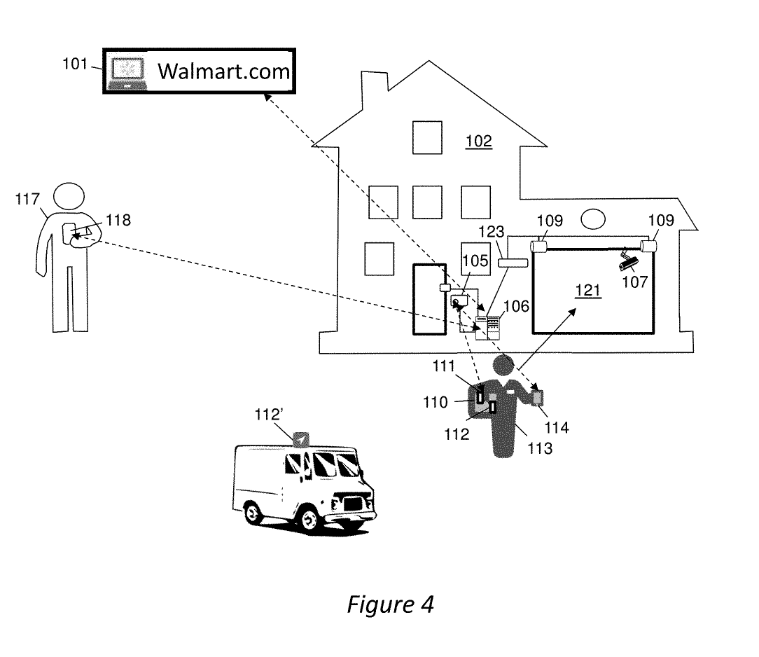

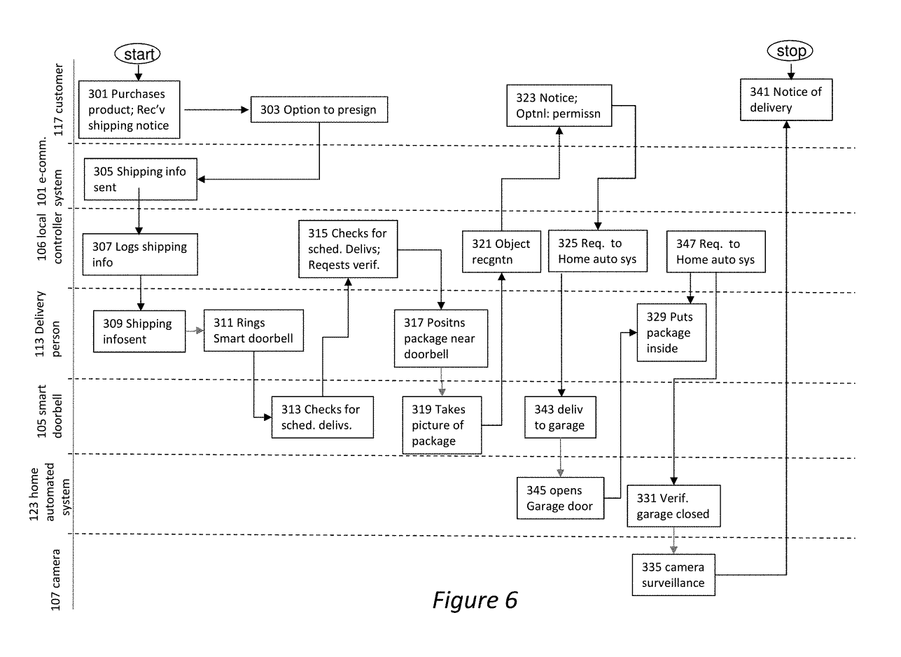

The structure and functioning of another automated system 100 for receiving a package will be described in connection with the workflow diagram of FIG. 6 and the structure shown in FIGS. 3 and 4.

In step 301 of FIG. 6 a customer 117 interacts through a customer's mobile device 118 to connect to an e-commerce system 101 to purchase a product on-line. This product is intended to be delivered as a package 110 to a delivery location (building 102) identified by customer 117. The customer 117 typically receives a shipping notice on customer's mobile device 118 from e-commerce system 101.

In step 303, the customer 117 is given an option to authorize delivery without requiring a signature when delivered. This is referred to pre-signing for package 110.

In step 305, e-commerce system 101 sends shipping information a local controller 106 in building 102. This shipping information will indicate package information, such as the type and size of the package, a predetermined code, such as a barcode, and some other identifying information allowing local controller 106 to identify the package. The shipping information may also indicate the date/time of arrival, or a time window of arrival being a period of time around an estimated time of arrival.

In step 307, local controller 106 logs the information received.

In step 309, driver, or delivery person 113 and delivery vehicle 115, brings package to building 102 for delivery. As indicate above, these may be from a separate delivery company.

In step 311, delivery person 113 rings a smart doorbell 105.

In step 313, the smart doorbell 105 interacts with local controller 106 to indicate that the doorbell was rung and request information on package delivery.

In step 315 the local controller 106 determine if it is close to a delivery time of arrival or within a delivery time window for delivery of a package 110 as previously specified by e-commerce system 101.

If not, the ringing of the smart doorbell 105 is ignored.

If so, a message is provided to the delivery person 113 to position an identification device 111 in a location/position so that the smart doorbell 105 can read package information from identification device 111. The message may be an audible message sent to a speaker in smart doorbell 105, a text message printed on the messaging screen on smart doorbell 105, or other means of locally notifying delivery person 113 of the instructions.

The smart doorbell 105 includes a package recognition device 119.

In one embodiment, the identification device 111 may be a barcode and the package recognition device 119 may be a barcode reader. In another embodiment the identification device 111 might be an RFID tag, and the package recognition device 119 can be an RFID reader. In another embodiment the identification device 111 may be a magnetic strip with coded information and the package recognition device 119 has the capability to read information from the magnetic strip.

In another embodiment, the identification device 111 may be a QR code, and the package recognition device is a QR code reader.

In still another embodiment the identification device is a visible feature, and the package recognition device 119 is a camera.

The information acquired by package recognition device 119 is then sent to local controller 106 for processing in step 319.

In step 321, local controller 106 processes the information received, then compares it to package information previously received from e-commerce system 101.

Optionally, in step 323 customer 117 receives a message on customer's mobile device 118 indicating that the package 110 is being delivered.

As indicated for a previous embodiment above, additionally, the identity of the delivery person 113 is verified/or the location of the delivery vehicle 115 for additional security.

In step 325 local controller 106 contacts a home automation system 123 that operates various devices in the house, such as a garage door opener 109 to open a garage door 121. The present invention may be retrofitted to an existing home automation system, or installed with the current system.

In an alternative embodiment, local controller 106 receives permission from customer 117 on customer's mobile device 118 before opening the garage door 121.

In step 343, smart doorbell 105 announces to the delivery person that the delivery should be made to the garage. In one embodiment, there can be an audio device such as a speaker connected to smart doorbell 105. In other embodiments, there can be a video display which can play a video which indicates the delivery should be made to the garage.

In step 345 the automated door opener 109 is activated to open garage door 121. In one embodiment the automated door opener 109 is activated by local controller 106. In another embodiment, automated door opener 109 is activated by local controller 106 acting through home automation system 123.

In step 329, delivery person 113 places package 110 into the garage and indicates that the delivery has been made.

In one embodiment, delivery person 113 activates driver's mobile device 114 to notify e-commerce system 101 that the delivery has been made. E-commerce system 101 then notifies local controller 106 that the delivery has been made, which then activates automated door opener 109 to close the garage door 121, or notifies home automation system 123 to activate automated door opener 109 to close the garage door 121.

In an alternative embodiment, the delivery person 113 is simply instructed to press a manual closed-door button for the automated door opener 109.

Home automation system 123, and or local controller 106 would read a sensor indicating the garage door has been closed.

In still another alternative embodiment, delivery person 113 operates driver's mobile device 114, to directly contact local controller 106 to indicate the delivery has been made. Local controller 106 then causes automated door opener 109 to close garage door 121. Delivery person 113 uses information provided by the customer 117 to e-commerce system 101 when the product was purchased to contact local controller 106 to indicate that the package has been delivered.

Optionally, internal cameras 107 may be activated to monitor the actions of delivery person 113.

In step 331, home automation system 123 verifies that the garage door has been closed.

In step 335, camera 107 verifies that the package has been delivered and that the delivery person 113 has not wandered around the garage.

In step 341, local controller sends a notification to customer's mobile device 118 notifying customer 117 that the package 110 has been delivered and it is secured within building 102.

If there are obstructions that don't allow the garage door to close, the delivery person is notified to correct the situation. This may be done by an audio message from an audio device in the garage coupled to the local controller 106 and/or automated home system 123.

In an alternative embodiment, the message may be sent to driver's mobile device 114 of delivery person 113. This way, there can be communication between the delivery person and the automatic system 100.

Although a few examples have been shown and described, it will be appreciated by those skilled in the art that various changes and modifications might be made without departing from the scope of the invention, as defined in the appended claims.

What is claimed is:

1. An automatic system for receiving a package purchased through an e-commerce system, delivered to a building, comprising:
an identification device having package information coupled to the package;
a local controller at the building adapted to communicate with the e-commerce system to receive package and delivery information;
an automated lock on the building functioning to lock or unlock an entrance to the building when activated;
a smart doorbell device adapted to include a package recognition device functioning to acquire the package information from the identification device when activated and the package is placed near the automated doorbell device;
wherein the local controller is coupled to the automated lock and the doorbell recognition device, and is adapted to:
activate the automated doorbell device to acquire package information from the identification device;
compare the package information acquired from the doorbell recognition device to package information provided by the e-commerce system
receive a time of arrival information (TOA) of the package to the building and create a delivery time window around the TOA; and
activate the automated lock to unlock an entrance to the building if the acquired package information from the doorbell recognition device is consistent with the package information provided by the e-commerce system, and is within the delivery time window.

2. The automatic system for receiving a package of claim 1, wherein:
the package is delivered by a delivery person having a delivery company identification device identifying the delivery company;
the e-commerce system is further adapted to provide the identity of the delivery company to the local controller;
the doorbell recognition device is further adapted to read the delivery company identification device to verify the identity of the delivery company; and
the local controller is further adapted to only open the automated lock when the identity of the delivery company matches an identify provided to the local controller by the ecommerce system.

3. The automatic system for receiving a package of claim 1, wherein the package further comprises:
a tracking device which provides location information of the package to the local controller in the building;
wherein the local controller is adapted to:
adjust the delivery time window based upon the location information provided by the tracking device; and
prevent the doorbell recognition device from accepting package information outside the delivery time window.

4. The automatic system for receiving a package of claim 1, wherein the tracking device repeatedly updates the local controller in the building with the location information to update the TOA and the delivery time window.

5. The automatic system for receiving a package of claim 1, wherein the doorbell recognition device employs at least one of the group consisting of a barcode reader, QR code reader, camera, RFID reader, Bluetooth transceiver and Near Field Communications (NFC) transceiver to acquire the package information.

6. The automatic system for receiving a package of claim 1, wherein the package identification device is at least one of the group consisting of a barcode, QR code, image, RFID reader, Bluetooth transceiver and NFC transceiver to identify the package.

7. The automatic system for receiving a package of claim 1, wherein messages are sent to a smartphone of the buyer by at least one of the group consisting of the package, doorbell recognition device, local controller and e-commerce system.

8. The automatic system for receiving a package of claim 1, further comprising a camera imaging the inside of the building adapted to record the actions of a delivery person.

9. The automatic system for a package of claim 1, where the cameras are web-enabled cameras that provide live feeds to a user's smartphone, and that further can be selected individually or as a group based on motion detected by the camera or through the user's choice.

10. The automatic system for receiving a package of claim 1, further comprising:
an audio system providing audible instructions to a delivery person.

11. The automatic system for receiving a package of claim 1, wherein the package information includes at least one of a bar code, QR code, digital watermark, package identification code, shipping information, location and time history of delivery, delivery instructions, contents, and buyer information.

12. The automatic system for receiving a package of claim 1, further comprising:
an automated door opener functioning to unlock and open or close and lock a door to the building when activated.

13. A method of automatically receiving a package ordered through an e-commerce system delivered to a building, comprising:
providing an identification device having package information on the package;
communicating package and delivery information from the e-commerce system to the local controller;
creating a delivery time window from the delivery information;
placing the package in proximity to a doorbell recognition device;
acquiring package information from the identification device by a doorbell recognition device within the delivery time window;
comparing the package information from the doorbell recognition device to the package information provided by the e-commerce system;
unlocking an automated lock on an entrance to the building when the doorbell recognition device identifies the package within the delivery time window, allowing a delivery person to bring the package inside the building; and
locking the entrance after the delivery person has left.

14. The method of claim 13, further comprising the step of:
receiving updates to the delivery time of the package;
updating the delivery time window;
acquiring package information from the identification device only within the updated delivery time window.

15. The method of claim 13, further comprising the step of:
monitoring the actions of the delivery person when inside of the building.

16. The method of claim 13, wherein the delivery information indicates the delivery company, and a delivery person has a delivery company identification device having information on the delivery company;
reading the delivery company information from company identification device with the doorbell recognition device to verify the identity of the delivery company.

17. An automatic system for receiving a package that was purchased on an e-commerce system that is delivered to a building having a home automation system capable of unlocking an entrance to the building, comprising:
an identification device having package information on the package;
a local controller at the building adapted to communicate with the e-commerce system to receive package and delivery information which include a delivery time window;
an automated lock on the building functioning to unlock and lock an entrance when activated;
a doorbell recognition device able to acquire package information from the identification device when the package is placed near the automated doorbell device, when activated;
wherein the local controller is coupled to the automated lock and the doorbell recognition device and is adapted to;
activate the automated doorbell device to acquire information from the identification device within a delivery window;
compare the package information acquired from the doorbell recognition device to package information provided by the e-commerce system; and
activate the home control system to unlock and open the entrance if the acquired package information from the doorbell recognition device is consistent with the package information provided by the e-commerce system, and within the delivery time window.

18. The automatic system for receiving objects of claim 17, wherein the package is delivered by a delivery truck that further comprises:
a tracking device which provides location information of the delivery truck to the local controller in the building;
wherein the local controller is adapted to determine from the location information when the delivery truck is within a predetermined distance of the building, and only activate the home control system to unlock an entrance when the delivery truck is within a predefined distance from the building.

19. The automatic system for receiving objects of claim 17, wherein the delivery information indicates the delivery company, and further comprising:
company identification device having information on the delivery company;
wherein the doorbell recognition device is adapted to read delivery company information from company identification device to verify the identity of the delivery company.

20. The automatic system for receiving objects of claim 17, further comprising:
sensors to determine the presence of a person within the building; and
the controller is further adapted to prevent unlocking the door for a delivery when a person is present in the building and reroute deliver to one of a garage, and alternative location.
